(19) United States
(12) Patent Application Publication
(10) Pub. No.: US 2016/0221157 A1
(43) Pub. Date: Aug. 4, 2016

(54) Gripping Head

(71) Applicant: Matrix GmbH Spannsysteme und Produktionsautomatisierung, Ostfildern-Nellingen (DE)

(72) Inventor: Andreas Brucker, Stuttgart (DE)

(21) Appl. No.: 15/013,583

(22) Filed: Feb. 2, 2016

(30) Foreign Application Priority Data
Feb. 4, 2015 (DE) 10 2015 101 599.4

(51) Int. Cl. B25B 1/24; B25B 1/10

(52) U.S. Cl. CPC B25B 1/2421; B25B 1/10

(57) ABSTRACT

A gripping head for gripping objects of various shapes has a basis and a gripping jaw linearly guided at the basis in a gripping direction. The gripping jaw comprises a frame and pins. Each pin is oriented in the gripping direction and has a front surface forming a segment of a gripping surface of the gripping jaw, and each pin can be pushed into the frame against a reset force until a fixing device operated by an operation element supported at the basis fixes the pins to the frame. The fixing device comprises an eccentric which is pivoting about an axis running perpendicularly to the gripping direction, and a pivoted lever coupled to the eccentric for simultaneous rotation. The pivoted lever is pivoted by the operation element, when the gripping jaw is forwarded in the gripping direction.

### CROSS REFERENCE TO RELATED APPLICATIONS

This application claims priority to German patent application No. DE 10 2015 101 599.4 entitled “Greifkopf” and filed on Feb. 4, 2015.

### FIELD OF THE INVENTION

The present invention relates to gripping head for gripping or clamping objects of various shapes, the gripping head comprising a gripping jaw with gripping pins.

### PRIOR ART

German patent application publication DE 198 02 320 A1, corresponding to EP 0 857 544 B1, discloses a holding apparatus for workpieces comprising a clamping jaw with movable clamping pins, a clamping device for applying a clamping force directed to a workpiece onto the clamping jaw, and a fixing device providing a fixing force for fixing the clamping pins to a frame of the clamping jaw. The clamping device is also used for forwarding the clamping jaw until its elastically supported clamping pins abut against the workpiece. A common translational operation element is provided for both the clamping device and the fixing device. Via a control head, the common translational operation element acts upon both a pressure piece of the fixing means and the entire clamping jaw. Control surfaces provided between the control head and the pressure piece are inclined angle with regard to a direction of an operation force originally provided by the operation element. Due to the inclination of the control surfaces, the operation force provided by the operation element is split up into the clamping force and the fixing force. For holding a workpiece, the clamping jaw is at first forwarded by forwarding the operation element, and as long as its clamping pins are not in contact with the workpiece, the clamping jaw is forwarded without hindrance, i.e. there is neither a relevant clamping force nor a relevant fixing force. As soon as the clamping pins abut against the workpiece and are pressed into the frame against elastic reset forces with any further advance of the clamping jaw, the clamping force is built up. Due to the inclined control surfaces, an even higher fixing force results at the same time so that the clamping pins are fixed to the frame of the clamping jaw shortly after they abut against the workpiece. An essential part of the force originally provided by the operation element, however, still acts upon the clamping jaw and has to be supported by the workpiece.

International patent application publication WO 2014/032981 A1 discloses a gripping head having a basis and a gripping jaw linearly guided at the basis in a gripping direction. The gripping jaw comprises a frame and several pins which are each oriented in the gripping direction. The front surfaces of the pins define a gripping surface of the gripping jaw for gripping an object. Generally, each of the pins may be pushed into the frame against a reset force. On the other hand, the pins can be fixed to the frame. For this purpose, a fixing element is guided at the frame in a direction perpendicular to the gripping direction, and operated via an inclined surface of a force dividing element which is supported at the basis in the gripping direction. When the gripping jaw, for gripping an object, is forwarded with regard to the basis in the gripping direction, the fixing element is pushed against the inclined surface of the force dividing element by the frame of the gripping jaw. With any further advance of the gripping jaw, the gripping force, to an increasing extent, is deviated into a fixing force onto the pins perpendicular to the gripping direction, until any further advance of the gripping jaw and any further application of gripping forces onto the object to be gripped are prevented.

United States patent application publication US 2005/0269757 A1 discloses a reconfigurable clamp for providing support for a variety of different body panel configurations. The clamp includes an adjustable contact portion comprising a plurality of pins slidably engaged within sleeves formed in a body portion. The pins include a head portion and a shaft portion extending from the head portion, wherein the shaft portion has an engageable portion. The clamp further comprises a plurality of slidably mounted rods disposed generally transverse to the movement of the pins within the sleeves. The slidably mounted rods have a complementary engageable portion that lockingly engages the engageable portion of the shaft portion upon contact therewith to selectively prevent further movement of the pins within the sleeves once a workpiece is loaded onto the clamp. For lockingly engaging the engageable portion of the shaft portion, the plurality of rods are forwarded by means of moving a movable base comprising a guide hole for each rod. The movable base is in operative communication with a cam coupled to a rotable shaft running in parallel to the pins. Rotating the cam moves the movable base with the rods. The rods are isolated from one another by means of springs as load transmitting elements arranged in the guiding holes of the movable base.

United Stated patent application publication US 2006/0108729 A1 discloses a multi-purpose clamping device for holding irregularly shaped objects by means of a stationary and a movable jaw, a linear ratchet and a rotary power cam. The known multi-purpose clamping device further comprises a pair of conformable jaw faces consisting of an array of springs-loaded pins to grasp the workpiece, and a base to which the jaws carrying the jaw faces are mounted.

There still is a need of a gripping head which allows for gripping objects of various shapes in a simple and secure way without damaging the objects.

### SUMMARY OF THE INVENTION

The present invention provides a gripping head for gripping objects of various shapes. The gripping head comprises a basis and a gripping jaw linearly guided at the basis in a gripping direction. An operation element is supported at the basis in the gripping direction. The gripping jaw comprises a frame, a plurality of pins and a fixing device. Each pin of the plurality of pins is oriented in the gripping direction and has a front surface forming one of a plurality of segments of a gripping surface of the gripping jaw. The fixing device comprises an eccentric pivoting about an axis running perpendicularly to the gripping direction, and a pivoted lever coupled to the eccentric for simultaneous rotation of the pivoted lever and the eccentric. The fixing device is operated by the operation element when the gripping jaw is forwarded in the gripping direction in that the pivoted lever is pivoted by the operation element so that the simultaneously pivoting eccentric fixes the plurality of pins to the frame. Each pin of the plurality of pins, in opposite direction to the gripping direction, can be pushed into the frame against a reset force until the fixing device is operated.

Other features and advantages of the present invention will become apparent to one with skill in the art upon examination of the following drawings and the detailed description. It is intended that all such additional features and advantages be included herein within the scope of the present invention, as defined by the claims.

### SHORT DESCRIPTION OF THE DRAWINGS

The invention can be better understood with reference to the following drawings. The components in the drawings are not necessarily to scale, emphasis instead being placed upon clearly illustrating the principles of the present invention. In the drawings, like reference numerals designate corresponding parts throughout the several views.

FIG. 1 is a sectional view of a gripping head.

FIG. 2 shows the gripping head according to FIG. 1 in a side view.

FIG. 3 is a side view corresponding to FIG. 2 showing the gripping head according to FIGS. 1 and 2 after moving its gripping jaw with regard to its basis in a gripping direction; and

FIG. 4 shows a further gripping head in a sectional view.

### DETAILED DESCRIPTION

The present invention is based on the finding that using a fixing element supported at an inclined surface of a force dividing element, in a gripping head comprising a basis and gripping jaws with pins results in a tilting effect on the gripping jaw about the contact area between the fixing element and the force dividing element. This tilting effect tilts the gripping jaw until it becomes wedged in its linear guiding. Thus, according to the invention, the use of a fixing device is proposed that is constructed in another way and whose functional principle is not based on the interaction of inclined surfaces.

The gripping head according to the present invention for gripping objects of various shapes comprises a basis and a gripping jaw which is linearly guided at the basis in a gripping direction. The gripping jaw comprises a frame and a plurality of pins which are aligned with the gripping direction and which form a gripping surface of the gripping jaw with their front faces. Normally, each of the pins, in a direction opposite to the gripping direction, can be pushed into the frame against a reset force. Particularly, the pins, when contacting an object to be gripped may be pushed into the frame in such a way that the gripping surface provided by the front faces of the pins is adapted to the shape of the object to be gripped.

For fixing the pins with regard to the frame, when the gripping surface has been adapted to the shape of the object to be gripped, and if for example the object shall be gripped with a higher gripping force than provided by the elastic support of the pins at the frame, the gripping head has a fixing device which fixes the pins to the frame. The fixing device is operated via an operation element supported at the basis. In contrast to the gripping devices known from the prior art, operation of the fixing device, however, is not based on the interaction of inclined surfaces. Instead, the fixing device according to the invention comprises a pivoted lever which is pivoted by the operating element and which is coupled for simultaneous rotation to an eccentric of the fixing device. The coupling for simultaneous rotation is designed such that the eccentric upon operating the pivoted lever by the operating element is pivoted about an axis running perpendicular to the gripping direction. Thus, a force acting on the pivoted lever in pivoting direction of the pivoting lever is transformed in a fixing force acting upon the pins perpendicularly to the gripping direction, by which the pins are fixed to the frame. As the fixing force is originally applied by pivoting the pivoted lever, the path of the movement of the gripping jaw with regard to the operation element is strongly reduced by the eccentric and any friction hindering this movement—in contrast to the case of an inclined surface—acts over the reduced path and may thus be overcome by the forces increased with the path reduction easily. Due to these facts no relevant tilting effect is exerted on the gripping jaw of the gripping head according to the present invention.

The fixing behavior of the fixing device may for example be tuned via the translation of the pivoting movement of the pivoted lever into the pivoting movement of the eccentric about its axis oriented perpendicular to the gripping direction. If a pivoted lever with a long lever arm is used, there is a particularly soft operation of the fixing device which particularly effectively counteracts wedging of the gripping jaw when fixing the pins.

In the gripping head according to the invention, the fixing force is only applied when the operation element gets into interaction with the pivoted lever and pivots the pivoted lever. Preferably, the gripping head is constructed in such a way that the gripping jaw can be moved without hindrance, particularly without already applying the fixing force to the pins up to the object to be gripped. With further moving the gripping jaw and applying a gripping force in the gripping direction, the object to be gripped pushes the pins into the frame so that the gripping surface formed by the front faces of the pins is adapted to the shape of the object. As soon as the operation element gets into contact with the pivoted lever and pivots the pivoted lever, the gripping force exerted onto the gripping jaw in the gripping direction is transformed into a force applied to the pivoted lever and thus via the eccentric into the fixing force perpendicular to the gripping direction to an increasing extent. Thus, a further movement of the gripping jaw in the gripping direction and a further application of forces by the pins of the gripping jaw to the object to be gripped may be effectively inhibited.

In a gripping head according to the present invention, a position of the operation element with regard to the basis is preferably adjustable in the gripping direction. For example, the operation element may be connected to the basis via a threaded spindle rotating in a fixed position with regard to the basis. By means of the position of the operation element, it may particularly be determined when or at what position of the gripping jaw the gripping force is transformed into the fixing force, and when or at what position of the gripping jaw a further movement of the gripping jaw in the gripping direction is stopped. Thus, it is possible to adapt the gripping head to objects to be gripped of different sizes in such a way that these objects do not directly or via already completely pushed in pins rigidly abut against the frame of the gripping jaw but get into contact with the gripping surface over an extended surface area. Further, the position of the operation element may be used to adjust the translation of the gripping force into the fixing force for fixing the pins. Particularly, the position of the operation element defines whether and how much of the gripping force has to be finally supported by the surface of the object to be gripped.

As an alternative or in addition to the adjustability of the position of the operation element, a starting position of the pivoted lever may be adjustable with regard to a starting position of the eccentric. In this way it may also be adjusted when and to what extent the gripping force is transformed into the fixing force.

It may be an advantage, if the pivoted lever, upon removing the gripping jaw from the object, automatically returns into its starting position so that the fixation of the pins with regard to the frame is simultaneously removed. For this purpose, a reset spring may be provided which provides a reset force biasing the pivoted lever into its starting position.

For other applications it may, however, be an advantage, if the fixation of the pins to the frame remains even after removing the gripping jaw from the object. In these cases, a locking element may be provided for the pivoted lever, by which the pivoted lever can be automatically locked in its pivoted position or by which it can be manually locked so that the fixing force is still applied to the pins after removing the gripping jaw from the object and the pins remain fixed to the frame.

According to an embodiment of the invention, the pivoted lever is coupled to the eccentric via a transmission. By means of the transmission, the path reduction between the movement of the pivoted lever caused by the operation element and the fixing movement of the eccentric with regard to the pins may be increased further.

The pivoted lever may, however, be simply rigidly connected to the eccentric so that the eccentric and the pivoted lever are pivoted together about the pivot axis of the eccentric.

In the gripping head according to the present invention, the eccentric may directly get into contact with at least some of the pins so that the fixing force is directly applied by the eccentric to these pins. In this way, friction losses may be minimized. To ensure that all pins are fixed to the frame, the eccentric is preferably made as an eccentric shaft extending perpendicularly to the gripping direction. Preferably, the eccentric shaft is at least about as long as the width of the area of the frame in which the pins are arranged.

Instead of a direct contact, a fixing element may be provided between the eccentric and the pins, via which the fixing force exerted by the eccentric is applied to the pins. For example, the fixing element may be made as a plate whose dimensions are adapted to the dimensions of the area defined by the frame in which the pins are arranged.

The fixing element may be guided at the frame in a direction perpendicular to the gripping direction. In this way, canting or tilting of the fixing element may be avoided. Further, it can be ensured that the fixing force applied to the pins is only exerted in a direction perpendicular to the gripping direction and that no friction between the eccentric and the pins results in a shift of the pins in or against the gripping direction.

A controlled increase of the fixing force exerted on the pins may be achieved in that an elastic fixing force buffer is arranged between the eccentric and the pins. If an additional fixing element is provided, the fixing force buffer may be provided between the eccentric and the fixing element and/or between the fixing element and the pins, or the fixing element may itself be designed as the fixing force buffer. For example, the fixing force buffer may be a pad made of an elastomeric material or the like.

An optimization of the course of the fixing force and thus also of the gripping force that is applied by the pins to the object to be gripped may be achieved in a particularly easy way by means of an exchangeable fixing force buffer. For example, the transformation of the gripping force into the fixing force occurs with a steeper increase with a stiff fixing force buffer than with a soft fixing force buffer.

In the gripping head according to the present invention, the pins and/or the springs that provide the reset forces for the pins may also be exchangeable. By means of exchanging the pins and/or the springs, the behavior of the gripping jaw in gripping an object and particularly the course of the force between the pins and the surface of the object may be adjusted. If the pins are exchangeable, pins optimized for gripping the respective object depending on the properties of the object to be gripped, for example depending on its form, material or sensitivity, may be used. For example, the different pins may differ in shape and/or surface properties of their front faces and/or the material used for the pins. Here, it may be sufficient not to exchange the pins as a whole but only their end sections providing the front faces.

Preferably, the gripping head according to the present invention comprises two gripping jaws linearly guided at the basis in opposing gripping directions. In this case, the two gripping jaws are preferably of a same basic construction, each gripping jaw having a fixing device and an associated operation element.

Typically, the two gripping jaws are mirror-symmetric to each other with regard to a center plane perpendicular to the gripping directions. Thus, an object to be gripped may be gripped in a same way from both sides.

When two gripping jaws are provided, their movements in their gripping directions may be coupled so that, for example, an operation of the pivoted lever and thus the exertion of the fixing force occurs simultaneously in both gripping jaws. For ensuring this, the gripping jaws may be coupled via a transmission. It may, however, be sufficient that same elastic reset forces opposite to the gripping directions act between the gripping jaws and the basis.

The positions of the two operation elements at the basis may simultaneously be adjusted in a particularly easy way by means of a rotating threaded spindle mounted to the basis in a fixed position. The two operation elements are then screwed onto threads of opposite pitches of the threaded spindle so that the operation elements upon rotating the threaded spindle are symmetrically moved towards or away from each other with regard to the basis.

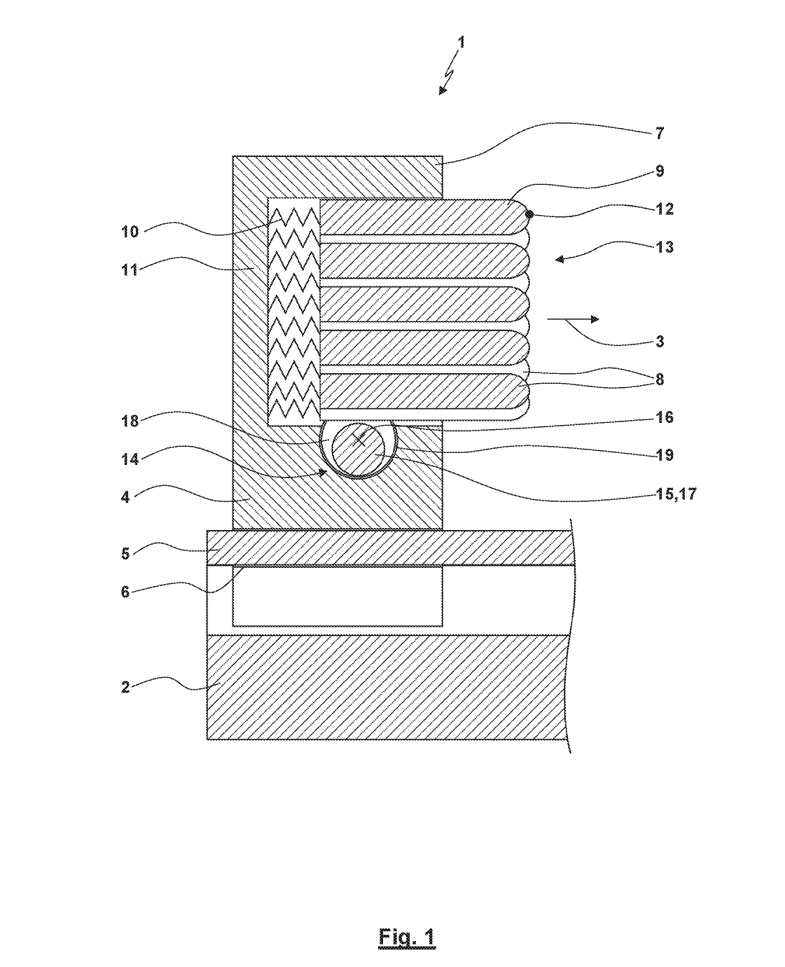

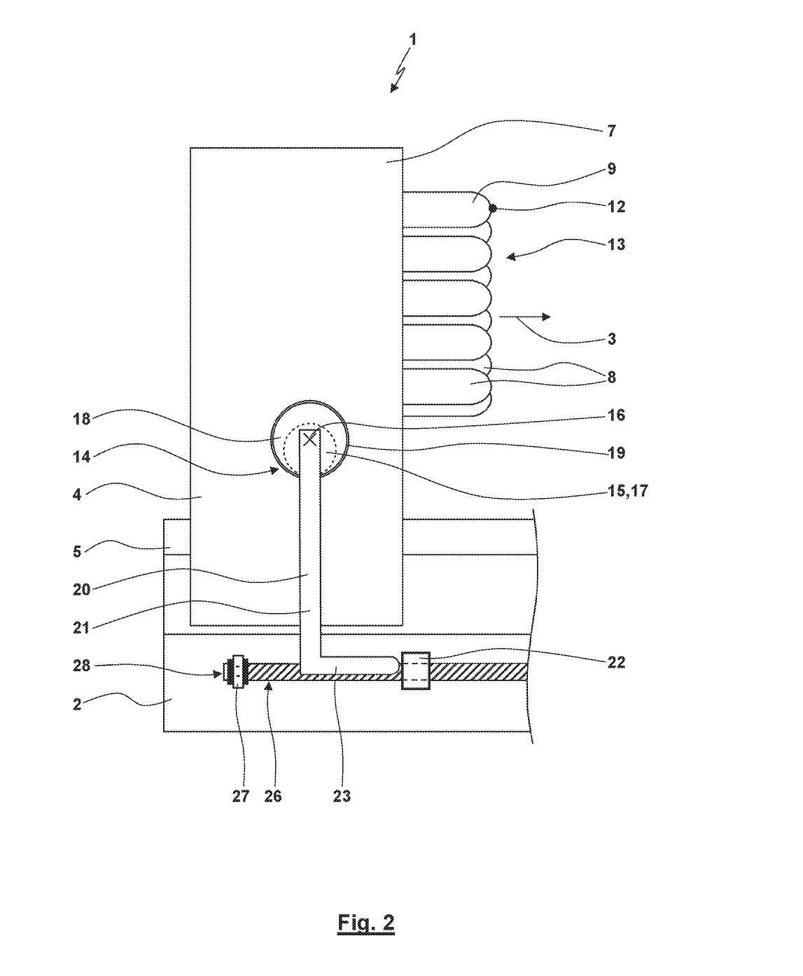

Now referring in greater detail to the drawings, FIGS. 1 and 2 show an embodiment example of a gripping head 1 according to the present invention. The gripping head 1 has a basis 2 and a gripping jaw 4 linearly guided at the basis 2 in a gripping direction 3. In the particular embodiment example depicted in FIGS. 1 and 2, a guiding rail 5 extending in the gripping direction 3 is provided at the basis 2, which engages a guiding notch 6 of the gripping jaw 4.

The gripping jaw 4 comprises a frame 7 closed around the gripping direction 3, and a plurality of pins 8 arranged within the frame 7. The pins 8 are parallel to each other and extend in the gripping direction 3. With their end sections pointing in the gripping direction 3, the pins 8 protrude beyond the frame 7.

The pins 8 abut against a back wall 11 of the frame 7 via pressure springs 10. In the position of the gripping jaw 4 depicted in FIGS. 1 and 2, the pins 8 may individually or all together be pushed into the frame 7 against reset forces provided by the springs 10. The reset forces provided by the springs 10 bias the pins 8 into their positions depicted in FIGS. 1 and 2. By means of front faces 12 of their end sections 9 the pins 8 form a gripping surface 13. The gripping surface 13 can be adapted to a surface contour of an object to be gripped in that the pins 8 are pushed into the frame 7 to a different extent corresponding to the surface contour of the object to be gripped.

The gripping head 1 has a fixing device 14 for fixing the pins 8 to the frame 7 and thus for fixing the gripping surface 13 adapted to the surface contour of the object so that the object is held in a defined position with regard to the basis 2 and/or so that forces may be purposefully exerted on the object with regard to other objects. Via the fixing device 14, a fixing force acting perpendicularly to the gripping direction 3 is exerted on the pins 8 for fixing the pins 8 to the frame 7. For providing this fixing force, the fixing device 14 comprises a cam or eccentric 15 which is mounted within the gripping jaw 4 so that it rotates about an axis 16 which is perpendicular to the gripping direction 3. In the embodiment example depicted in FIGS. 1 and 2, the eccentric 15 is made as an eccentric shaft 17 with stub shafts 18 at its ends which engage into openings 19 in the frame 7 and which are rotating about the axis 16. The eccentric shaft 17 extends over the entire width of the frame 7.

Besides the eccentric 15, the fixing device 14 has a pivoted lever 20 fixed for rotation with the eccentric 15. The pivoted lever 20 is L-shaped, the free end of its longer leg 21 being fixed to one of the stub shafts 18 of the eccentric 15.

From the stub shaft 18 the pivoted lever 10, with its longer leg 21, extends perpendicularly to the axis 16 and thus essentially perpendicularly to the gripping direction 3 until its other end is in front of an operation element 22 supported at the basis 2 via a threaded spindle 26. In the position depicted in FIG. 2, a shorter leg 23 of the pivoted lever 20 extends perpendicularly to the axis 16 in front of the operation element 22 and thus essentially in the gripping direction 3.

When the gripping jaw 4, with regard to the basis 2, is moved in the gripping direction 3 to such an extent that the pivoted lever 20 gets into contact with the operation element 22, any further movement of the gripping jaw 4 in the gripping direction 3 pivots the pivoted lever 20 and the eccentric 15.

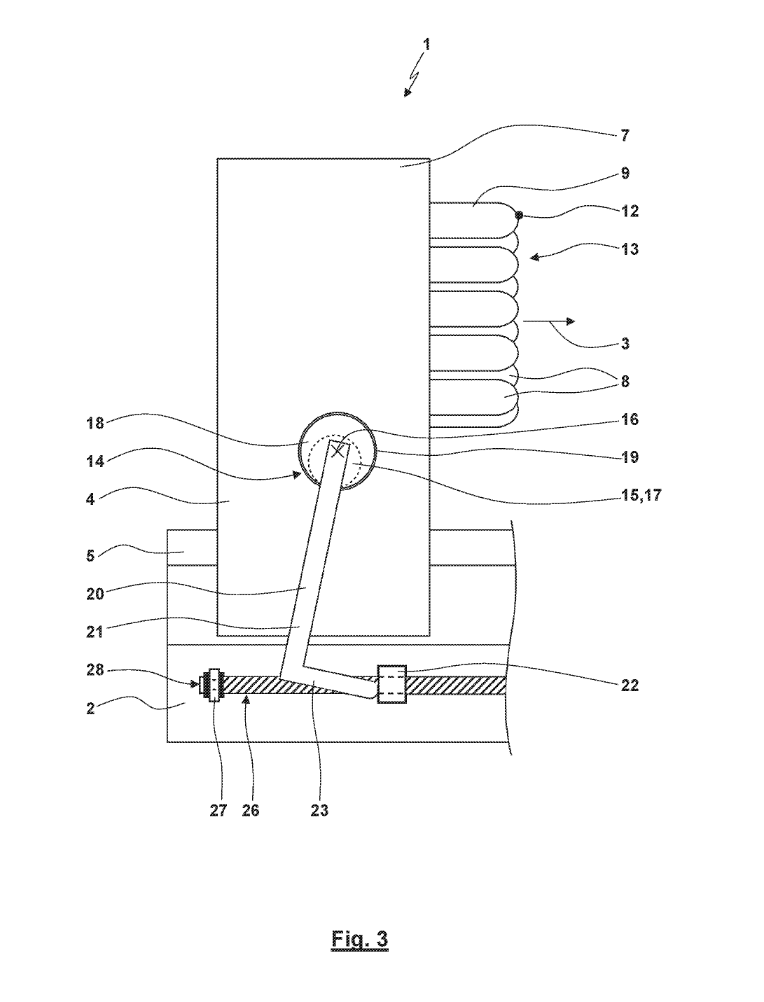

In FIG. 3, an operated position of the pivoted lever 20 is depicted in which the pivoted lever 20 is pivoted by the operation element 22 out of its starting position depicted in FIG. 2 backwardly against the gripping direction 3. Due to the pivoted lever 20 being pivoted, the eccentric 15 has also been pivoted or rotated out of its starting position. The rotation of the eccentric 15 about its axis 16 results in that a distance of the eccentric shaft 17 to the pins 8 is reduced until the eccentric shaft 17—as depicted in FIG. 3—gets into contact with at least one of the pins 8. With further pivoting the eccentric 15, an increasing fixing force is exerted on the pins 8 by which the pins 8 are finally fixed to the frame 7.

By means of the fixing device 14 constructed in this way, a gripping force on the gripping jaw 4 in the gripping direction 3 and transferred to the pivoted lever 20 in the pivoting direction is transformed by the eccentric 15 into a fixing force perpendicular to the gripping direction 3, by which the pins 8 are fixed to the frame 7. Here, the gripping force applied to the gripping jaw 4 for moving the gripping jaw 4 in the gripping direction 3 is transformed into the fixing force acting perpendicular to the gripping direction 3 to an extent increasing with the movement of the gripping jaw 4. Thus, a secure fixation of the positions of the pins 8 is achieved, on the one hand; and a further movement of the gripping jaw 4 in the gripping direction 3 and an exertion of further forces on the object are effectively inhibited, on the other hand. Consequently, even sensitive objects can be gripped with the gripping head 1 without damaging them.

In which position of the gripping jaw 4 with regard to the basis 2 the gripping force is transformed into the fixing force acting perpendicularly to the gripping direction 3, depends on when the pivoted lever 20 gets into contact with the operation elements 22 and is operated by the operation element 22. Correspondingly, by means of the relative position of the operation element 22 and the pivoted lever 20, the fixing behavior may be influenced. For adjusting the fixing behavior, the operation element 22 is connected to the basis 2 in such a way that its position with regard to the basis 2 may be varied in the gripping direction 3. Particularly, the threaded spindle 26 is axially supported at the basis 2 in a bearing 27. By engaging a spindle head 28 for rotating the threaded spindle 26, the operation element 22 not rotating with the threaded spindle 26 is moved along the threaded spindle. Thus, the position of the gripping jaw 4 is adjusted, at which the pivoted lever 20 gets into contact with the operation element 22.

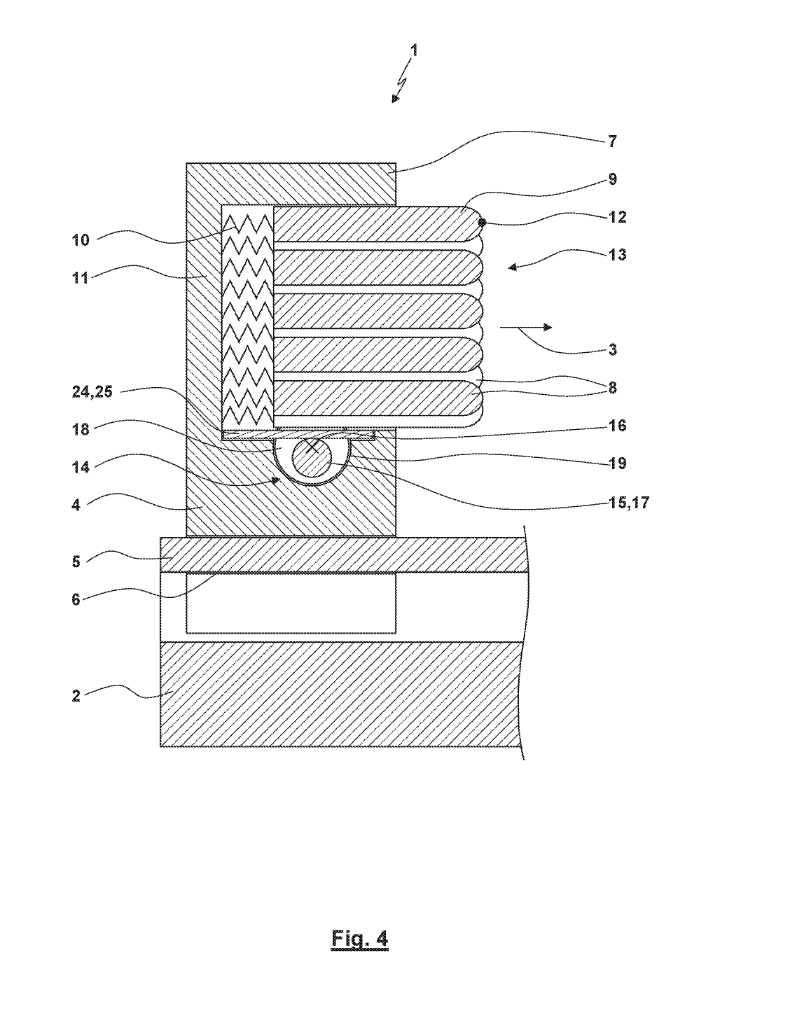

In FIG. 4 a further embodiment example of the gripping head 1 is depicted in which the fixing device 14 additionally comprises a fixing element 24 which is arranged between the eccentric 15 and the pins 8. The fixing element 24 may for example be made as fixing plate 25 whose width essentially comprises to the width of the frame 7 in which the pins 8 are arranged. In the gripping direction 3, the fixing element 24 is supported at the frame 7, i.e. it is guided at the frame 7 perpendicularly to the gripping direction 3.

By means of arranging the fixing element 24 between the eccentric 15 and the pins 8, the pins 8 are not directly contacted by the eccentric 15 and thus not possibly moved forward by the eccentric 15 before they are fixed to the frame 7. Instead, by pivoting the pivoted lever 20 and the resulting pivoting movement of the eccentric 15, the fixing element 24 guided at the frame 7 is solely against the pins 8 perpendicularly to the gripping direction 3. Thus, any force exerted by the eccentric 15 and transferred onto the pins 8 via the fixing element 3 is just the desired fixing force directed perpendicularly to the gripping direction 3. Further, the fixing element 3 may be elastic. This helps in uniformly distributing the fixing force over the entire width of the frame 7 and thus over all of the pins 8.

Many variations and modifications may be made to the preferred embodiments of the invention without departing substantially from the spirit and principles of the invention. All such modifications and variations are intended to be included herein within the scope of the present invention, as defined by the following claims.

I claim:

1. A gripping head for gripping objects of various shapes, the gripping head comprising
a basis and
a gripping jaw linearly guided at the basis in a gripping direction,
wherein an operation element is supported at the basis in the gripping direction;
wherein the gripping jaw comprises a frame, a plurality of pins and a fixing device,
wherein each pin of the plurality of pins is oriented in the gripping direction and has a front surface forming one of a plurality of segments of a gripping surface of the gripping jaw,
wherein the fixing device comprises an eccentric pivoting about an axis running perpendicularly to the gripping direction, and a pivoted lever coupled to the eccentric for simultaneous rotation of the pivoted lever and the eccentric,
wherein the fixing device is operated by the operation element when the gripping jaw is forwarded in the gripping direction in that the pivoted lever is pivoted by the operation element so that the simultaneously pivoting eccentric fixes the plurality of pins to the frame, and
wherein each pin of the plurality of pins, in opposite direction to the gripping direction, can be pushed into the frame against a reset force until the fixing device is operated.

2. The gripping head of claim 1, wherein a position of the operation element with regard to the basis is adjustable in the gripping direction.

3. The gripping head of claim 1, wherein a starting position of the pivoted lever with regard to the eccentric is adjustable.

4. The gripping head of claim 1, wherein a reset force on the pivoted lever acts against pivoting the pivoted lever out of its starting position.

5. The gripping head of claim 1, wherein a locking element locks the pivoted lever in its pivoted position.

6. The gripping head of claim 1, wherein the pivoted lever is coupled to the eccentric via a transmission.

7. The gripping head of claim 1, wherein the pivoted lever is rigidly connected to the eccentric.

8. The gripping head of claim 1, wherein the eccentric comprises an eccentric shaft.

9. The gripping head of claim 1, wherein the fixing device comprises a fixing element arranged between the eccentric and the pins.

10. The gripping head of claim 9, wherein the fixing element is guided at the frame in a direction perpendicular to the gripping direction.

11. The gripping head of claim 1, wherein an elastic fixing force buffer is provided between the eccentric and the pins.

12. The gripping head of claim 11, wherein the fixing force buffer is exchangeable.

13. The gripping head of claim 1, wherein the pins are exchangeable.

14. The gripping head of claim 1, wherein the springs exerting the reset forces on the pins are exchangeable.

15. The gripping head of claim 1, wherein the position of the operation element in the gripping direction is adjustable by means of rotating a threaded spindle supported at the basis in the gripping direction and provided with a thread onto which the operation element screwed.

16. The gripping head of claim 1, wherein a further gripping jaw with a further fixing device is linearly early guided at the basis in the direction opposite to the gripping direction and that a further operation element for operating the further fixing device of the further gripping jaw is supported at the basis.

17. The gripping head of claim 16, wherein the gripping jaw and the further gripping jaw are symmetrical with regard to a center plane running perpendicularly to the gripping direction.

18. The gripping head of claim 16, wherein the movement of the gripping jaw in the gripping direction and the movement of the further gripping jaw in the direction opposite to the gripping direction are coupled.

19. The gripping head of claim 16, wherein the positions of the operation element in the gripping direction and the further operation element in the direction opposite to the gripping direction are simultaneously adjustable by means of rotating a threaded spindle supported at the basis in the gripping direction and the direction opposite to the gripping direction, and provided with two threads of opposite pitches onto which the operation element and the further operation element are screwed.
